(19) United States
(12) Patent Application Publication
(10) Pub. No.: US 2004/0204009 A1
(43) Pub. Date: Oct. 14, 2004

(54) Mobile phone with electromagnetic radiation reduction structure

(76) Inventors: Yung-Fa Cheng, Taipei (TW); Hsiang-Lung Kao, Taipei (TW); Chun-Lung Chen, Taipei (TW); Kuo-Hsiang Wu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/281,535

(22) Filed: Oct. 28, 2002

(30) Foreign Application Priority Data
Jun. 26, 2002 (TW) 91209640

(51) Int. Cl. H04B 1/00

(52) U.S. Cl. 455/550.1; 455/90.1

(57) ABSTRACT

A mobile phone with an electromagnetic radiation reduction structure. The mobile phone comprises a liquid crystal display, a printed circuit board, a keyboard, and a battery. The printed circuit board includes a radio frequency shielding device and a baseband circuit. The radio frequency shielding device and the baseband circuit are disposed on the printed circuit board. The liquid crystal display is coupled to the printed circuit board. The keyboard is coupled to the printed circuit board. The battery is disposed between the keyboard and the printed circuit board. The battery, the frequency shielding device, the baseband circuit, and the liquid crystal display are disposed on the same side of the printed circuit board.

### BACKGROUND OF THE INVENTION

1. Field of the Invention

The invention relates to a mobile phone, in particular, a mobile phone with an electromagnetic radiation reduction structure.

2. Description of the Related Art

Mobile phones are more and more popular, providing many conveniences. However, with the increase of handset use, electromagnetic radiation on the user's body has become a serious concern. According to the Standard, Specific Absorption Rate (SAR), the ratio between the mass of the user's body and the energy of electromagnetic radiation, is an important way to evaluate the effect of electromagnetic radiation on the user's body. Especially, since, in most mobile phone use, the handset is near the head so that the brain is completely within the range of electromagnetic radiation.

Thus, a shielding unit for preventing the transmission of electromagnetic radiation is additionally attached outside the mobile phone. However, such conventional shielding unit not only increases the weight of the whole mobile phone, but also the cost. Thus, it is not popular. Furthermore, the source of electromagnetic radiation is usually located near or on a printed circuit board of the mobile phone since the printed circuit board is coupled to an antenna. In addition, it is well known that the intensity of electromagnetic radiation is inversely proportional to the distance. The location of the printed circuit board in the mobile phone can be adjusted so as to be more removed from the user's body during operation. As a result, the effect of electromagnetic radiation of the mobile phone on the user's body can be minimized.

FIG. 1 and FIG. 2 show a conventional mobile phone. As shown in FIG. 1, a keyboard 2 is disposed on a printed circuit board 3, and is combined with a top cover 1. The printed circuit board 3 is coupled to a liquid crystal display 31 via a flexible printed circuit 32. The printed circuit board 3 includes a radio frequency (RF) shielding device 33 and a baseband circuit 34 on the other side. A battery 5 is disposed below the baseband circuit 34, and in the mobile phone by a bottom cover 4 engaging a battery cover 6. The top cover 1 is combined with the bottom cover 4 to complete the assembly of the whole mobile phone.

As stated above, in the conventional mobile phone, the distance between the printed circuit board 3 and a top surface of the mobile phone is equal to a total thickness of top cover 1 and the keyboard 2 or the liquid crystal display 31. That is, as shown in FIG. 2, the distance between the printed circuit board 3 and the top surface of the mobile phone is very small. If the radio frequency shielding device 33, the baseband circuit 34, and the battery 35 are not disposed below the printed circuit board 3, the printed circuit board 3 can be farther from the user's body. In addition, the bottom cover must be cut to be form a hole so that the battery and the battery cover are convenient to assemble. Thus, the structural strength of the whole mobile phone is weakened.

### SUMMARY OF THE INVENTION

In order to address the disadvantages of the aforementioned mobile phone, the invention provides a mobile phone with an electromagnetic radiation reduction structure.

Another purpose of this invention is to provide a mobile phone with a low SAR value.

Still another purpose of this invention is to provide a mobile phone with enhanced structural strength.

Accordingly, the invention provides a mobile phone with an electromagnetic radiation reduction structure. The mobile phone comprises a liquid crystal display, a printed circuit board, a keyboard, and a battery. The printed circuit board includes a radio frequency shielding device and a baseband circuit. The radio frequency shielding device and the baseband circuit are disposed on the printed circuit board. The liquid crystal display is coupled to the printed circuit board. The keyboard is coupled to the printed circuit board. The battery is disposed between the keyboard and the printed circuit board. The battery, the radio frequency shielding device, the baseband circuit, and the liquid crystal display are disposed on the same side of the printed circuit board.

In a preferred embodiment, the mobile phone further comprises a first flexible printed circuit for coupling the keyboard and the printed circuit board.

In another preferred embodiment, the mobile phone further comprises a second flexible printed circuit for coupling the liquid crystal display and the printed circuit board.

The invention also provides another mobile phone. The mobile phone comprises a first cover, a printed circuit board, a liquid crystal display, a keyboard, and a battery. The printed circuit board is disposed in the first cover, and includes a radio frequency shielding device and a baseband circuit. The radio frequency shielding device and the baseband circuit are located on a side of the printed circuit board. The printed circuit board is located between the radio frequency shielding device, the baseband circuit and the first cover. The liquid crystal display is disposed on the printed circuit board. The liquid crystal display, the radio frequency shielding device and the baseband circuit are located on the side of the printed circuit board. The liquid crystal display is coupled to the printed circuit board. The radio frequency shielding device and the baseband circuit are located between the liquid crystal display and the printed circuit board. The keyboard is disposed on the printed circuit board. The keyboard, the radio frequency shielding device and the baseband circuit are located on the side of the printed circuit board. The keyboard is coupled to the printed circuit board. The battery is disposed on the printed circuit board and located between the keyboard and the printed circuit board. The battery, the keyboard, the frequency shielding device, the baseband circuit, and the liquid crystal display are disposed on the same side of the printed circuit board. The second cover is connected with the first cover so that the printed circuit board and the liquid crystal display are received in the first cover and the second cover.

### BRIEF DESCRIPTION OF THE DRAWINGS

The invention is hereinafter described in detail with reference to the accompanying drawings in which:

FIG. 1 is an exploded view of a conventional mobile phone;

FIG. 2 is a cross section of a conventional mobile phone;

FIG. 3 is an exploded view of a mobile phone as disclosed in this invention; and

FIG. 4 is a cross section of the mobile phone in FIG. 3.

### DETAILED DESCRIPTION OF THE INVENTION

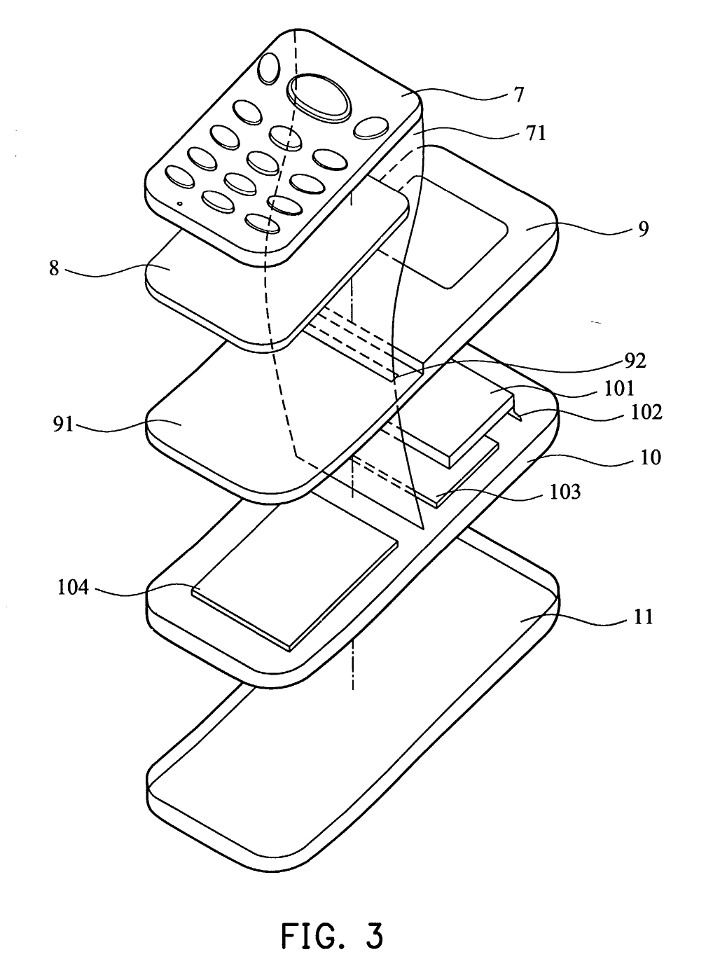

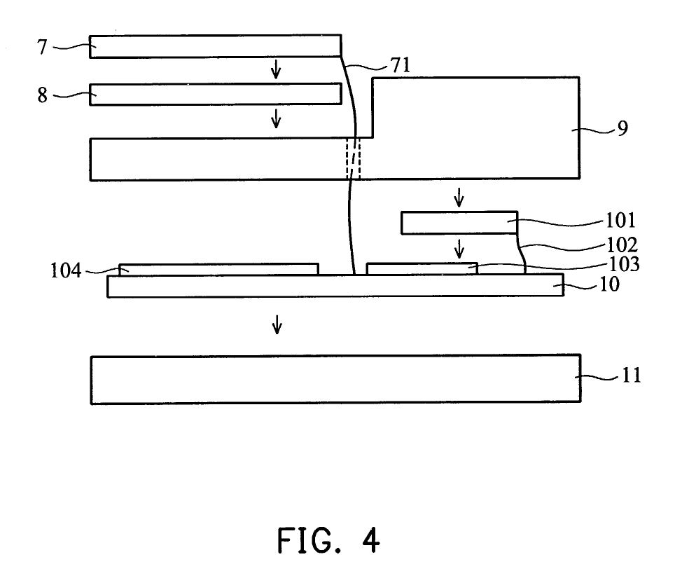

FIG. 3 is an exploded view of a mobile phone as disclosed in this invention, and FIG. 4 is a cross section of the mobile phone in FIG. 3.

As shown in FIG. 3, the mobile phone as disclosed in this invention comprises a top cover 9, a keyboard 7, a battery 8, a printed circuit board 10 and a liquid crystal display 101. The top cover 9 is formed with a concave portion 91 and a through hole 92. The battery 8 is disposed between the keyboard 7 and the top cover 9. The battery 8 and the keyboard 7 are disposed in the concave portion 91 of the top cover 9. The printed circuit board 10 includes a radio frequency shielding device 103 and a baseband circuit 104. The radio frequency shielding device 103 and the baseband circuit 104 are disposed on the printed circuit board 10. The liquid crystal display 101 is coupled to the printed circuit board 10 via a flexible printed circuit 102. The keyboard 7 is coupled to the printed circuit board 10 via a flexible printed circuit 71 through the through hole 92. A bottom cover 11 is combined with the top cover 9 to complete the assembly of the mobile phone.

The characteristic of this invention is that the battery 8, the radio frequency shielding device 103, the baseband circuit 104, and the liquid crystal display 101 are located on the printed circuit board 10. That is, the battery 8, the radio frequency shielding device 103, the baseband circuit 104, and the liquid crystal display 101 are located on the same side of the printed circuit board 10 as the keyboard 7. Thus, in the mobile phone as disclosed in this invention, the printed circuit board 10 is directly adjacent to the bottom cover 11, and is attached to the bottom cover 11. In addition, the other components are disposed on the printed circuit board 10, and are located on the same side of the printed circuit board 10. As a result, compared with the distance between the printed circuit board of the conventional mobile phone and the user's body, the distance between the printed circuit board of the mobile as disclosed in this invention and the user's body is much larger.

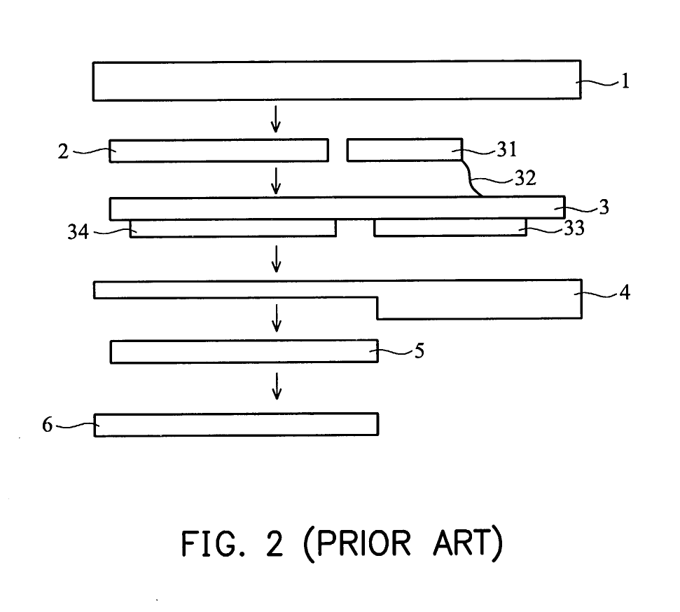

Referring to FIG. 4, the battery 8, the radio frequency shielding device 103, and the baseband circuit 104 are located between the printed circuit board 10 and the keyboard 7. In contrast, in the conventional mobile phone as shown in FIG. 2, the keyboard 2 is directly disposed on the printed circuit board 3. Thus, since the components in the mobile phone are only repositioned in this invention, the whole size of the mobile phone remains the same. Also, since the distance between the printed circuit board that is electromagnetic radiation source and the user's body is significantly increased in this invention, the effect of electromagnetic radiation from the mobile phone on the user's body is minimized.

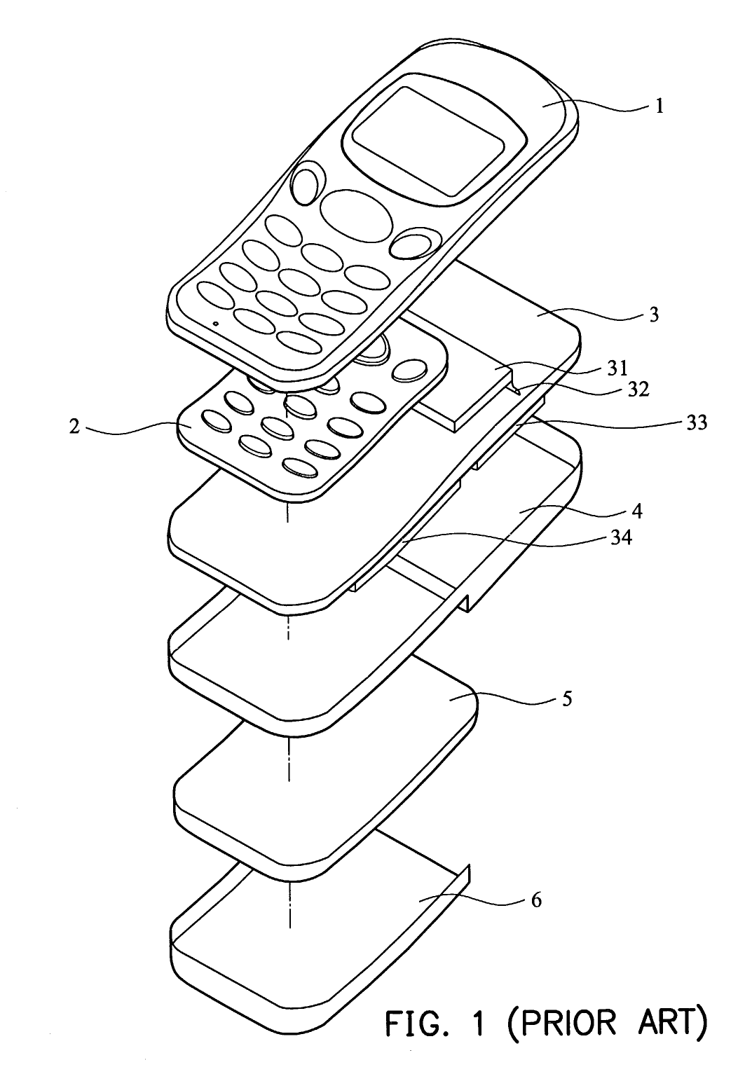

In addition, the battery 8 is disposed between the keyboard 7 and the printed circuit board 10, and is located on the same side of the printed circuit board 10 as the liquid crystal display 101. Thus, the bottom cover 11 is not required to be cut to form a hole for the battery 8 to be detached. As a result, compared to the bottom cover 4 as shown in FIG. 1, the structural strength of the bottom cover 11 as disclosed in this invention is improved.

After changing the positions of the components in the mobile phone, the appearance and the function of the mobile phone as disclosed in this invention are the same as a normal mobile phone. Also, in practical use, there is no need to attach additional accessories to the mobile phone as disclosed in this invention so that the original design of the mobile phone can be kept intact. Furthermore, since the distance between the printed circuit board and the user's body is increased, the SAR generated by the mobile phone is largely reduced so that the security of the mobile phone is enhanced during operation.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiments, those alternatives which have been discussed above, and all equivalents thereto.

What is claimed is:

1. A mobile phone comprising:
a liquid crystal display;
a printed circuit board including a radio frequency shielding device and a baseband circuit, wherein the radio frequency shielding device and the baseband circuit are disposed on the printed circuit board, and the liquid crystal display is coupled to the printed circuit board;
a keyboard coupled to the printed circuit board; and
a battery disposed between the keyboard and the printed circuit board;
wherein the battery, the frequency shielding device, the baseband circuit, and the liquid crystal display are disposed on a side of the printed circuit board.

2. The mobile phone as claimed in claim 1, further comprising:
a first flexible printed circuit for coupling the keyboard and the printed circuit board.

3. The mobile phone as claimed in claim 1, further comprising:
a second flexible printed circuit for coupling the liquid crystal display and the printed circuit board.

4. A mobile phone comprising:
a first cover;
a printed circuit board, disposed in the first cover, including a radio frequency shielding device and a baseband circuit, wherein the radio frequency shielding device and the baseband circuit are located on a side of the printed circuit board, and the printed circuit board is located between the radio frequency shielding device, the baseband circuit and the first cover;
a liquid crystal display disposed on the printed circuit board, wherein the liquid crystal display, the radio frequency shielding device and the baseband circuit are located on the side of the printed circuit board, and the liquid crystal display is coupled to the printed circuit board, and the radio frequency shielding device and the baseband circuit are located between the liquid crystal display and the printed circuit board;
a keyboard disposed on the printed circuit board, wherein the keyboard, the radio frequency shielding device and the baseband circuit are located on the side of the printed circuit board, and the keyboard is coupled to the printed circuit board;
a battery disposed on the printed circuit board and located between the keyboard and the printed circuit board, wherein the battery, the keyboard, the frequency shielding device, the baseband circuit, and the liquid crystal display are disposed on the side of the printed circuit board; and
a second cover connected with the first cover so that the printed circuit board and the liquid crystal display are received in the first cover and the second cover.

5. The mobile phone as claimed in claim 4, further comprising:
a first flexible printed circuit for coupling the keyboard and the printed circuit board.

6. The mobile phone as claimed in claim 4, further comprising:
a second flexible printed circuit for coupling the liquid crystal display and the printed circuit board.
